(19) United States
(12) Patent Application Publication
(10) Pub. No.: US 2013/0159859 A1
(43) Pub. Date: Jun. 20, 2013

(54) METHOD AND USER DEVICE FOR GENERATING OBJECT-RELATED INFORMATION

(71) Applicant: KT CORPORATION, Seongnam (KR)

(72) Inventors: Ju-Yong LEE, Incheon (KR); Jin-Han KIM, Gunpo-si (KR); Se-Jun PARK, Daejeon (KR); Hoon-Kyu PARK, Suwon-si (KR); Han-Wook JUNG, Seoul (KR)

(73) Assignee: KT CORPORATION, Seongnam (KR)

(21) Appl. No.: 13/722,000

(22) Filed: Dec. 20, 2012

(30) Foreign Application Priority Data
Dec. 20, 2011 (KR) 10-2011-0138291

(51) Int. Cl. G06F 3/0484

(52) U.S. Cl. CPC G06F 3/04842
USPC 715/719

(57) ABSTRACT

A method, performed by a user device, includes receiving a user input for selecting an object displayed on a screen of the user device while reproducing video contents, detecting position information of the selected object and reproduction time information when the object is selected on the screen and transmitting the position information and the reproduction time information to a contents information management server.

### CROSS-REFERENCE TO RELATED PATENT APPLICATION

This application claims priority from the Korean Patent Application No. 10-2011-0138291, filed on Dec. 20, 2011 in the Korean Intellectual Property Office, the entire disclosure of which is incorporated herein by reference.

### BACKGROUND

1. Field

Exemplary embodiments broadly relate to a method and a user device for generating object-related information and more specifically, exemplary embodiments relate to a method and a user device for generating object-related information by selecting an object displayed on a screen of the user device while reproducing video contents.

2. Description of the Related Art

With recent development of technology, the number of devices used by users has increased and generally, a single user has used multiple devices.

A user is provided with contents, specifically, a video, by using such devices. There has been increasing demand for additional information of the contents as well as the contents.

Because of such demand, in order to provide additional information of contents, there has been suggested a technique for registering and providing additional information of the contents.

In a related art, Korean Patent No. 0895293 describes a technique for providing additional information of a digital object within frames to a user by linking a tag ID, position information, and time information with the digital object within the frames, and Korean Patent No. 0479799 describes a technique in which if a user selects an object from a frame, information of the object is searched by using coordinates of the object and frame information, and the searched information of the object is provided to the user.

However, in the related art, a user does not recognize an object within a frame, but a video provider recognizes the object within the frame, and inputs and provides additional information to the user. Therefore, it is impossible to satisfy a demand for classification and tagging of increasing video contents and a lot of effort and resources are needed to generate additional information.

### SUMMARY

Accordingly, it is an aspect to provide a method and a user device for generating information relevant to an object displayed reproduction screen corresponding to contents such as a video or the like by recognizing position information of the object and reproduction time information while the user device reproduces the contents, and by inputting additional information relevant to the object after the user device stops reproducing the contents.

According to an aspect of exemplary embodiments, there is a method performed by a device. The method includes receiving an input for selecting an object displayed on a screen of the device while reproducing video contents, detecting position information of the selected object and reproduction time information when the object is selected on the screen and transmitting the position information and the reproduction time information to a server.

If the input for selecting the object moves on the screen, the position information comprises a start position and an end position, and the reproduction time information comprises a start time and an end time.

If the input is continued for a predetermined time or for more than the predetermined time, an operation for determining that the input is an input for generating object-related information associated with the selected object, is performed.

The method may further comprise receiving, from the server, an interface configured to receive the object-related information and including information related to the selected object; receiving, through the interface, information about the selected object to generate the object-related information; and transmitting the generated object-related information to the server.

If the input is continued for a time shorter than a predetermined time, an operation of determining that the input is an input for requesting object-related information associated with the selected object, is performed.

The method may further comprise requesting the server to provide the object-related information associated with the selected object; and receiving and displaying the provided object-related information.

The method may further comprise acquiring an image of the screen when the input is either beginning or ending.

The receiving the input may comprise continuously selecting the object until the object disappears from the screen.

The method may further comprise determining whether the input is an input for one from among generating object-related information and requesting object-related information, based on a time in which the input is continued.

According to another aspect of exemplary embodiments, a device comprises a first receiver configured to receive an input for selecting an object on a screen of the device while video contents is being reproduced, a first detector configured to detect position information of the selected object, a second detector is configured to detect reproduction time information when the object is selected on the screen and a first transmitter configured to transmit the position information and the reproduction time information to a server.

If the input for selecting the object moves on the screen, the position information comprises a start position and an end position, and the reproduction time information comprises a start time and an end time.

The device may further comprise a determiner configured to determine whether the input is one from among an input for generating object-related information and an input for requesting object-related information

If the received input is continued for a predetermined time or for more than the predetermined time, the determiner determines that the user input is the input for generating object-related information, and if the input is continued for a time less than the predetermined time, the determiner determines that the user input is the input for requesting object-related information.

The user device may further comprise a second receiver configured to receive, from the server, an interface for receiving the object-related information which comprises information of the selected object, if the user input is the input for generating object-related information; a generator configured to receive, through the interface, information about the selected object to generate the object-related information; and a second transmitter configured to transmit the generated object-related information to the server.

The user device may further comprise a requester configured to request the server to provide the object-related information associated with the selected object, if the user input is the input for requesting object-related information; a receiver configured to receive the requested object-related information from the server; and a provider configured to display the received object-related information.

The input may be a touch-type input and the screen may be a touch-type screen.

The selected object may be operable to be continuously selected until the object disappears from the screen.

The determiner may determine whether the input is one from among an input for generating object-related information and an input for requesting object-related information, based on a time in which the input is continued.

A geographical location of the device may be determined when the input is received.

The reproduction time information may comprise one from among a time during which the object is selected and a time point at which the object is selected.

According to another aspect of exemplary embodiments, a method for generating object-related information comprises: receiving, at a device, an input to transmit a request for a user interface for generating object-related information corresponding to one or more objects displayed on a screen of the device while reproducing video contents; and transmitting the user interface to the device in response to the request.

The input may be based on a selection, on a screen of the device, of at least one of the one or more objects. The input may be based on an input to stop reproduction of the video contents.

In exemplary embodiments, it is possible for the user to generate information relevant to an object displayed reproduction screen corresponding to contents such as a video by easily recognizing position information of the object and reproduction time information of the contents by with an input device of a user device to store the information in a server while the user watches the contents, and inputting the information relevant to the object.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a view illustrating a configuration of an object-related information generating system according to an exemplary embodiment;

FIG. 2 is a procedure diagram illustrating an example of a method of recognizing an object by a user device according to an exemplary embodiment;

FIG. 3 is a flow diagram illustrating a method of recognizing an object according to an exemplary embodiment;

FIG. 4 is a flow diagram illustrating a method of generating object-related information according to an exemplary embodiment;

FIG. 5 is a block diagram illustrating a user device according to an exemplary embodiment ;

FIG. 6 is a procedure diagram illustrating a method of transmitting position information and reproduction time information according to an exemplary embodiment;

FIG. 7 is a diagram illustrating a user interface according to an exemplary embodiment; and

FIG. 8 is a procedure diagram illustrating a method of providing object-related information according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

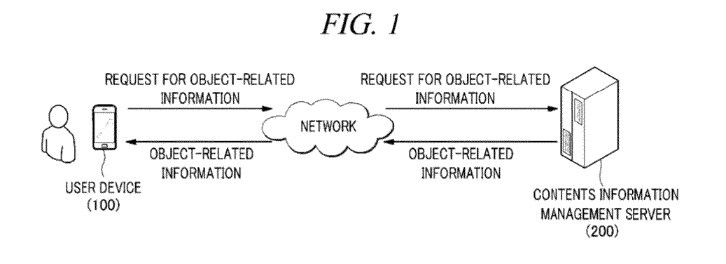

FIG. 1 is a view illustrating a configuration of an object-related information generating system according to an exemplary embodiment.

According to an exemplary embodiment, a user device 100 reproduces video contents provided by a contents providing server (not illustrated), which provides contents to a contents information management server 200 or the user device 100.

While reproducing the video contents, the user device 100 receives a user input depending on an input type of the user device from the user. By way of example, if the user device 100 provides a touch type input device, the user can generate a user input by touching a screen of the user device 100 while the video contents is reproduced.

Further, if the user device 100 provides an input device such as a mouse, the user can generate a user input by using a cursor controlled with the mouse.

As described above, the user can select a displayed object from the contents being reproduced by the user device 100 by using the input device of the user device 100. By way of example, the user can select a displayed object at the user device 100 by touching the object on a screen with a finger or a pen. Hereinafter, the exemplary embodiment will be explained on the premise that the user device 100 provides a touch type input device.

The user device 100 detects position information of an object selected by a user input on a screen and also detects reproduction time information by selecting the object and then transmits the detected position information and reproduction time information to the contents information management server 200 through a network.

That is, the user device 100 detects the position information of the object being touched by the user and also detects the reproduction time information corresponding to the video contents. In case the touch continues on the screen, the reproduction time information may include a start time of the touch to an end time of the touch, and then transmits the detected position information and reproduction time information to the contents information management server 200 to store them.

Further, in addition to the position information and reproduction time information, the user device 100 acquires an image of the screen when the touch is started or when the touch is ended and transmits the acquired image to the contents information management server 200 to store it.

If the user device 100 transmits a request for a user interface to generate object-related information to the contents information management server 200, the contents information management server 200 transmits the user interface including the acquired image corresponding to the reproduction time, the position information, and the reproduction time information to the user device 100. Alternatively, the user device can display a user interface previously stored in the user device.

The user device 100 inputs information about the object by using the received user interface to generate the object-related information, and transmits the generated object-related information input by the user to the contents information management server 200 to store it in the contents information management server 200 so as to be matched with a corresponding contents, the position information, and the reproduction time information.

If the user device 100 or other devices request the object-related information, the object-related information stored in the contents information management server 200 can be provided to the user device 100 or the other devices.

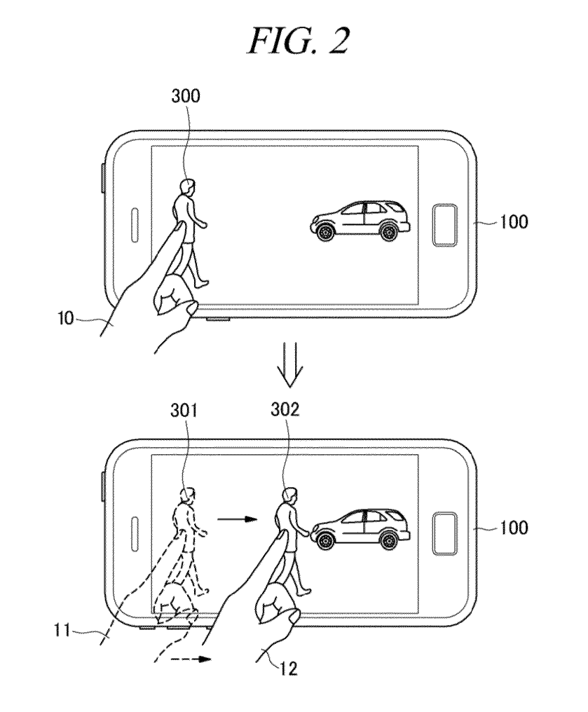

FIG. 2 is a diagram illustrating an example of a method of recognizing an object by a user device according to an exemplary embodiment.

According to an exemplary embodiment, the user device 100 may provide a touch type input device.

The user can touch an object 300 with his/her finger 10 while video contents is provided through the user device 100. In this case, the user device 100 can detect position information and reproduction time information at the time when the user touches a screen.

The user can keep inputting, i.e. touching the screen, until the object 300 disappears from the screen. If the object 300 is moved from a first position 301 to a second position 302, the user can move the touch along with the moved object while continuing to touch the screen.

Therefore, in this case, the finger 10 of the user can move from a third position 11 corresponding to the first position 301 to a fourth position 12 corresponding to the second position 302 along with the moved object 300.

The user device 100 recognizes a trajectory of the touch as the position information and also recognizes a time from a start time of the touch to an end time of the touch as the reproduction time information when the object is selected.

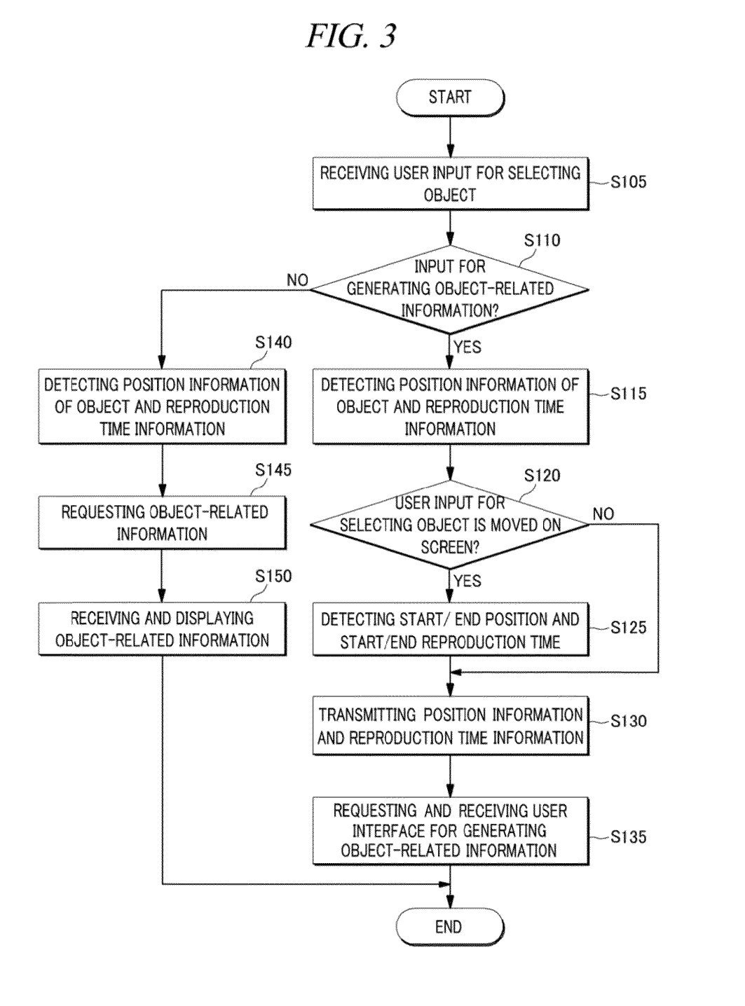

FIG. 3 is a flow diagram illustrating a method of recognizing an object according to an exemplary embodiment.

In operation S105, a user device receives a user input for selecting an object displayed on a screen of the user device while reproducing video contents. As described above, the user device can provide the user with various input types including a touch type or a cursor input type using for example, a mouse, a track ball, and a touch pad. The user can input an object selection to the user device by using such input types.

In operation S110, the user device determines whether the user input is an input for generating object-related information or an input for requesting object-related information. That is, the user can make an input for selecting the object to request object-related information as well as to generate object-related information.

The user device can determine whether the user input is an input for generating object-related information or an input for requesting object-related information based on a time in which the user input is continued, i.e., based on a duration of user input.

By way of example, if a user input is continued for 1 second or longer, the user device determines that the user input is an input for generating object-related information. If a user input is continued for a time shorter than 1 second, the user device determines that the user input is an input for requesting object-related information.

In operation S115, if the user input is determined as an input for generating object-related information in operation S110, the user device detects information of a position where the user input is made and also detects information of a reproduction time when the user input is made while a video contents is reproduced.

The detected information of the position is recognized as position information and the detected information of a reproduction time is recognized as reproduction time information when the object appears on the screen.

Further, the user device may detect a geographical location where the user device is located when the user input is made.

In operation S120, the user device determines whether or not the user input is moved on the screen of the user device. As described above, the user can select the object by clicking or touching a point where the object is positioned to input the object appearing on the screen. If the object is moved, the user can move a click point by dragging or a touch point by moving while being clicked or touching along a moving route of the object.

Accordingly, the user device determines whether or not the user input is moved to determine whether or not the object is moved.

In operation S125, if it is determined that the user input is moved in operation S120, the user device detects position information including a trajectory of the user input and reproduction time information including start time and end time. In this case, the position information may include a start position and an end position.

In operation S130, the user device transmits the position information and the reproduction time information detected in operation S115 or S125 to the contents information management server 200. The contents information management server 200 may temporarily store the received position information and the received reproduction time of the object recognized in response to the user input until the user device transmits a request for a user interface. Further, the user device may transmit the detected geographical location to the contents information management server 200.

In operation S135, the user device transmits a request for the user interface for generating object-related information to the contents information management server 200 and receives the user interface from the contents information management server 200. The user device may transmit the request for the user interface when receiving a user interface requesting signal, such as, a stop signal of the reproduced video contents from the user. Alternatively, the user device can display a user interface previously stored in the user device.

In an exemplary embodiment, the user device may transmit a request for the user interface for generating object-related information corresponding to multiple objects to the contents information management server 200.

In operation S140, if it is determined that the user input is an input for requesting object-related information in operation S110, the user device detects information of a position where the user input is made and also detects information of a reproduction time when the user input is made while a video contents is reproduced.

The detected information of the position is recognized as position information and the detected information of a reproduction time is recognized as reproduction time information when the object appears on the screen.

In operation S145, the user device requests the object-related information including the position information and the reproduction time information from the contents information management server 200.

In operation S150, the user device receives the object-related information requested in operation S145 from the contents information management server 200 and displays the received object-related information to provide it to the user.

The object-related information may be displayed by being overlaid on a reproduction screen being displayed.

According to an exemplary embodiment, while watching and enjoying contents, for example, video contents, a user can select an object of which information needs to be input, and if the selected object is moved, the user can continue selecting the object along a moving route of the object, and easily acquire position information of the object and reproduction time information when the object appears.

Further, after the position information and the reproduction time information are stored in a contents information management server 200, the user can input object-related information at any time the user wants by using the stored position information and reproduction time information. Therefore, the user can enjoy the contents independently from inputting the object-related information.

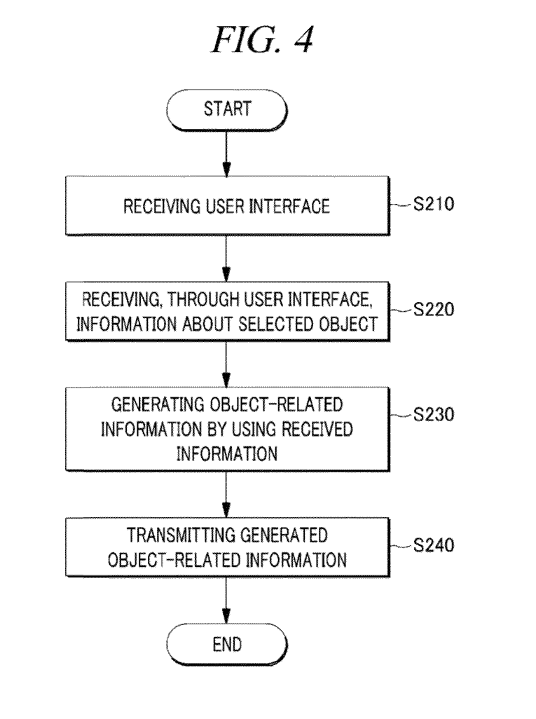

FIG. 4 is a flow diagram illustrating a method of generating object-related information according to an exemplary embodiment.

In operation S210, a user device receives a user interface from a contents information management server 200 in response to a request for the user interface. The user interface includes information of an object selected by a user, such as, position information, reproduction time information, geographical location information, acquired image information and so forth. Further, the user interface may include information of multiple objects.

In operation S220, the user device provides a user input device to the user, and receives information about the selected object through the received user interface by using the provided user input device.

If the user interface includes information of multiple objects, the user device may select a single object to generate object-related information corresponding to the single object among the multiple objects, and receive information about the selected single object.

In operation S230, the user device generates object-related information by using the received information about the object.

In operation S240, the user device transmits the generated object-related information to the contents information management server 200.

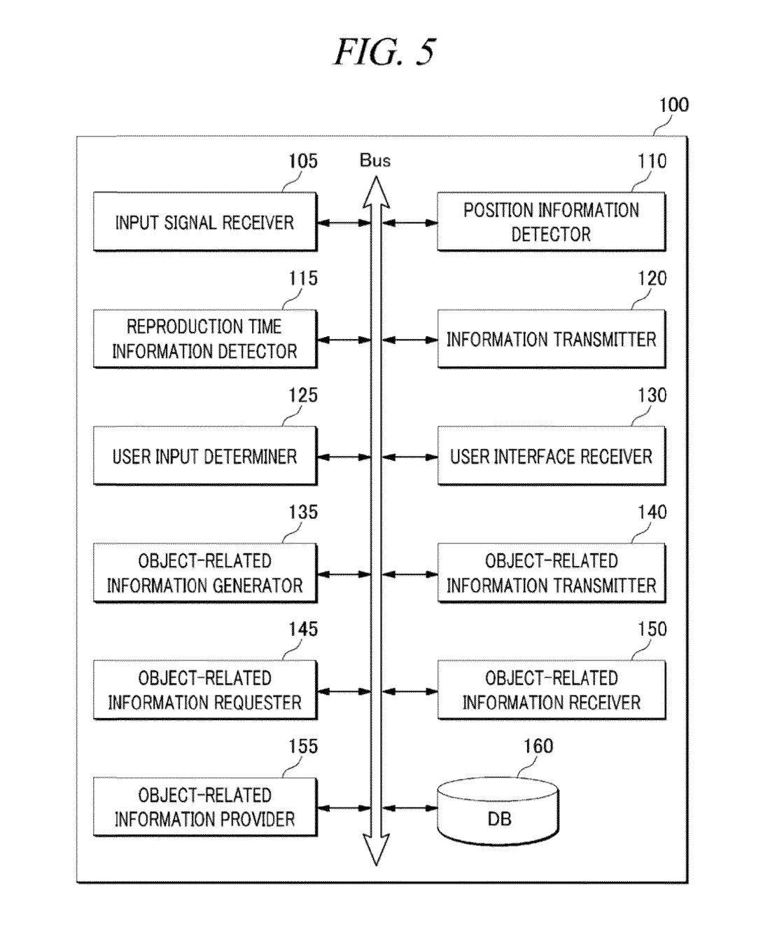

FIG. 5 is a block diagram illustrating a user device according to an exemplary embodiment.

The user device 100 according to an exemplary embodiment may include an input signal receiver 105, a position information detector 110, a reproduction time information detector 115, an information transmitter 120, an user input determiner 125, a user interface receiver 130, an object-related information generator 135, an object-related information transmitter 140, an object-related information requester 145, an object-related information receiver 150, an object-related information provider 155, and a database 160.

The input signal receiver 105 receives a user input for selecting an object on a screen of the user device while video contents is being reproduced. As described above, the user device 100 can provide various input types to the user and the user can make an input to select an object by using the various input types.

The position information detector 110 detects position information of the selected object. If the user device provides a touch type input device to the user, the position information detector 110 determines information of a position touched by the user as position information.

The reproduction time information detector 115 detects reproduction time information when the object is selected on the screen. That is, if the user makes an input to select an object while the video contents is reproduced, the reproduction time information detector 115 detects information of an object selection time. The reproduction time information detector 115 may detect information of a time while the object selection is continued as well as information of a time when the object selection is made.

The information transmitter 120 matches the detected position information and the detected reproduction time information with identification information of the video contents, and transmits them to the contents information management server 200.

The user input determiner 125 determines whether the user input is an input for generating object-related information or an input for requesting object-related information.

The user input determiner 125 determines whether the user input is an input for generating object-related information or an input for requesting object-related information based on a difference in a user input method.

By way of example, the user input determiner 125 determines whether the user input is an input for generating object-related information or an input for requesting object-related information based on whether or not an input holding time of the user is less than or greater than a predetermined time.

If the user input determiner 125 determines that the user input is an input for generating object-related information, the information transmitter 120 may request a user interface. Otherwise, the user device may separately transmit the request for the user interface when receiving a user interface requesting signal, such as, a stop signal of the reproduced video contents from the user.

The user interface receiver 130 receives, from the contents information management server 200, the user interface configured to receive the object-related information and including information of the selected object, if the user input is the input for generating object-related information.

The contents information management server 200 stores the position information and the reproduction time information in response to a receipt of the position information and the reproduction time information of an object selected by a user, and the contents information management server 200 transmits a user interface including the position information and the reproduction time information to the user device to generate object-related information in response to a receipt of a request for the user interface, and the user device generates the request for the user interface by receiving the user interface requesting signal, such as, a stop signal of the reproduced video contents from the user.

The user device may select a single object among multiple objects to receive a user interface corresponding to the single object. By way of example, the user device may select three objects to generate object-related information, and transmit a request for a user interface, and then the contents information management server 200 may request the acquired image the user wants to generate object-related information for, among the three acquired images, each acquired image corresponding to each selected object.

The object-related information generator 135 receives, through the user interface, information about the selected object, and generates the object-related information by using the received information about the selected object. The object-related information may include information which the user wants to share regarding the object.

According to another exemplary embodiment, the user device transmits the received information about the selected object to the contents information management server 200, and then the contents information management server 200 generates object-related information by using the received information about the selected object.

The object-related information may be overlaid on a reproduction screen being displayed.

The object-related information transmitter 140 transmits the object-related information generated by the object-related information generator 135 to the contents information management server 200.

The object-related information requester 145 requests the contents information management server 200 to provide the object-related information associated with the selected object, if the user input is the input for requesting object-related information.

The object-related information receiver 150 receives the object-related information requested by the object-related information requester 145 from the contents information management server 200.

The object-related information provider 155 displays the object-related information received by the object-related information receiver 150 to provide it to the user.

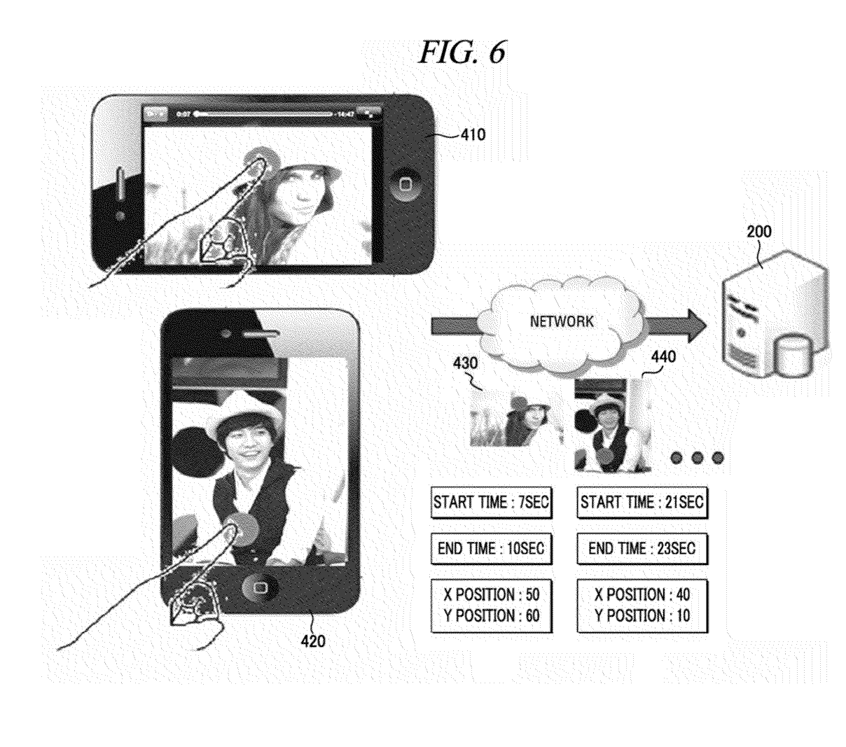

FIG. 6 is a procedure diagram illustrating a method of transmitting position information and reproduction time information according to an exemplary embodiment.

If a user selects objects displayed on the screen of user device 410 and 420 such as a person, clothes, or a product by means of a touch while video contents is reproduced through a user device by touching with a finger and taking the finger off, start time information and end time information for selecting objects, position information, such as coordinates, of the selected objects, and acquired image information 430 and 440 specifying the objects can be transmitted to the contents information management server 200.

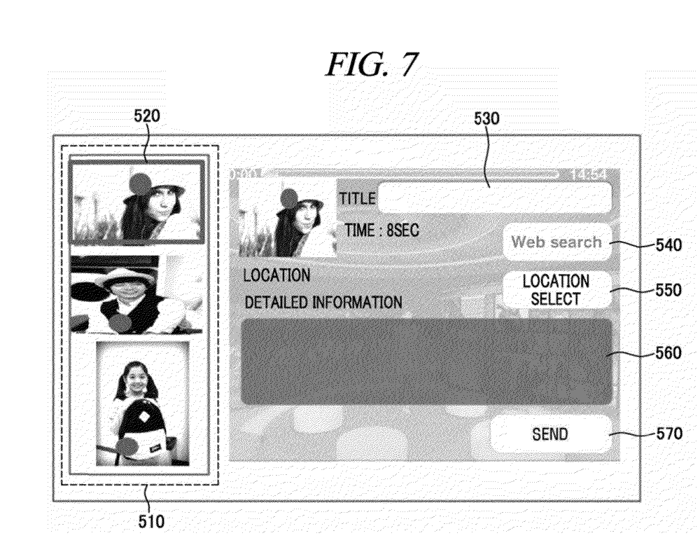

FIG. 7 is a diagram illustrating a user interface according to an exemplary embodiment.

A user device may receive, from the contents information management server 200, the user interface including one or more acquired image information temporarily stored after the objects are selected. The user device may provide the one or more acquired image information 510 to a user, and the user may select specific acquired image information 520 from the one or more acquired image information 510.

In response to the user selection, the user device may display the specific user interface, corresponding to the selected specific acquired image information, including a title window 530 for the selected object, a web search button 540 for searching detailed information through a web, a location select button 550 for specifying a location an object-related site, a detailed information window 560 for inputting the detailed information, and a send button 570 for transmitting generated object-related information to the contents information management server 200.

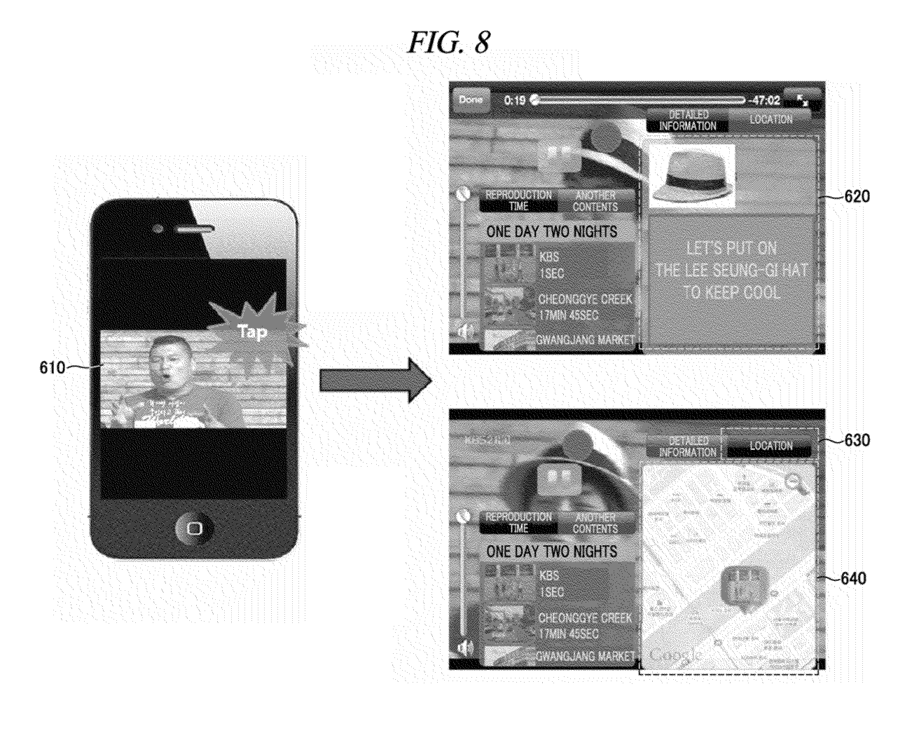

FIG. 8 is a procedure diagram illustrating a method of providing object-related information according to an exemplary embodiment.

A user requests object-related information of an object displayed on a screen 610 of the input device, for example, a touch screen, provided in the user device by touching the screen 610, and the user device receives object-related information 620 from the contents information management server 200 and provides it to the user.

Further, the user device may provide location information of an object-related site as the object-related information. By way of example, if the user selects a location button 630, the user device receives map information 640 including a location of an object-related site from the contents information management server 200 and provides it to the user.

Exemplary embodiments may be embodied in a transitory or non-transitory storage medium which includes instruction codes which are executable by a computer or processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of the exemplary embodiments. Thus, above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method performed by a device, the method comprising:
receiving an input for selecting an object displayed on a screen of the device while reproducing video contents;
detecting position information of the selected object and reproduction time information, when the object is selected on the screen; and
transmitting the position information and the reproduction time information to a server.

2. The method of claim 1, wherein if the input for selecting the object moves on the screen, the position information comprises a start position and an end position, and the reproduction time information comprises a start time and an end time.

3. The method of claim 1, further comprising:
if the input is continued for a predetermined time or for more than the predetermined time, determining that the input is an input for generating object-related information associated with the selected object.

4. The method of claim 3, further comprising:
receiving, from the server, an interface configured to receive the object-related information and including information related to the selected object;
receiving, through the interface, information about the selected object to generate the object-related information; and
transmitting the generated object-related information to the server.

5. The method of claim 1, further comprising:
if the input is continued for a time shorter than a predetermined time, determining that the input is an input for requesting object-related information associated with the selected object.

6. The method of claim 5, further comprising:
requesting the server to provide the object-related information associated with the selected object; and
receiving and displaying the provided object-related information.

7. A device comprising:
a first receiver configured to receive an input for selecting an object on a screen of the device while video contents is being reproduced;
a first detector configured to detect position information of the selected object;
a second detector is configured to detect reproduction time information when the object is selected on the screen; and
a first transmitter configured to transmit the position information and the reproduction time information to a server.

8. The device of claim 7, wherein if the input for selecting the object moves on the screen, the position information comprises a start position and an end position, and the reproduction time information comprises a start time and an end time.

9. The device of claim 7, further comprising:
a determiner configured to determine whether the input is one from among an input for generating object-related information and an input for requesting object-related information.

10. The device of claim 9, wherein if the received input is continued for a predetermined time or for more than the predetermined time, the determiner determines that the user input is the input for generating object-related information, and
if the input is continued for a time less than the predetermined time, the determiner determines that the user input is the input for requesting object-related information.

11. The device of claim 9, further comprising:
a second receiver configured to receive, from the server, an interface for receiving the object-related information which comprises information of the selected object, if the user input is the input for generating object-related information;
a generator configured to receive, through the interface, information about the selected object to generate the object-related information; and
a second transmitter configured to transmit the generated object-related information to the server.

12. The device of claim 9, further comprising:
a requester configured to request the server to provide the object-related information associated with the selected object, if the user input is the input for requesting object-related information;
a receiver configured to receive the requested object-related information from the server; and
a provider configured to display the received object-related information.

13. The device of claim 7, wherein the input is a touch-type input and the screen is a touch-type screen.

14. The method of claim 1, further comprising acquiring an image of the screen when the input is either beginning or ending.

15. The device of claim 13, wherein the selected object is operable to be continuously selected until the object disappears from the screen.

16. The method of claim 1, wherein the receiving the input comprises continuously selecting the object until the object disappears from the screen.

17. The method of claim 1, further comprising determining whether the input is an input for one from among generating object-related information and requesting object-related information, based on a time in which the input is continued.

18. The device of claim 7, wherein the determiner determines whether the input is one from among an input for generating object-related information and an input for requesting object-related information, based on a time in which the input is continued.

19. The device of claim 7, wherein a geographical location of the device is determined when the input is received.

20. The method of claim 1, further comprising determining a geographical location of the device when the object is selected.

21. The method of claim 1, wherein the reproduction time information comprises one from among a time during which the object is selected and a time point at which the object is selected.

22. The device of claim 7, wherein the reproduction time information comprises one from among a time during which the object is selected and a time point at which the object is selected.

23. A method for generating object-related information, the method comprising:
receiving, at a device, an input to transmit a request for a user interface for generating object-related information corresponding to one or more objects displayed on a screen of the device while reproducing video contents; and
transmitting the user interface to the device in response to the request.

24. The method according to claim 23, wherein the input is based on a selection, on a screen of the device, of at least one of the one or more objects.

25. The method according to claim 23, wherein the input is based on an input to stop reproduction of the video contents.
